(19) United States
(12) Patent Application Publication
(10) Pub. No.: US 2006/0266607 A1
(43) Pub. Date: Nov. 30, 2006

(54) Electric clutch actuator shifted inertia brake

(75) Inventors: Daniel A. Monette, Battle Creek, MI (US); Robert J. Bailey, Portage, MI (US); Alan C. Stine, Kalamazoo, MI (US)

Correspondence Address: Kevin J. Heinl;Brooks Kushman P.C., 22nd Floor, 1000 Town Center, Southfield, MI, 48075-1238, US

(73) Assignee: Eaton Corporation, Cleveland, OH (US)

(21) Appl. No.: 11/136,149

(22) Filed: May 24, 2005

(51) Int. Cl. F16D 67/02; F16D 11/06

(52) U.S. Cl. 192/15; 192/18 R

(57) ABSTRACT

A clutch assembly having a clutch, release bearing, and input shaft inertia brake assembly is disclosed. An electric clutch actuator shifts the release bearing axially along an input shaft of a transmission system to either engage the clutch or engage the input shaft inertia brake.

### BACKGROUND OF THE INVENTION

1. Field of the Invention

The present invention relates to an inertia brake that is actuated by an electric clutch actuator that engages and disengages a release bearing.

2. Background Art

Transmission research and development is directed to developing transmissions that meet performance standards relating to durability, shifting performance, and providing effective torque transfer. Other objectives may include reducing manufacturing and operational costs.

Digital controls for transmissions are being developed that improve shift performance to a point at which computer controlled shifting may be superior to shift performance of an experienced driver yet can be executed by the most inexperienced drivers. Digital controls may be used with electric clutches to shift the transmission by shifting the release bearing to engage and disengage the clutch. Electric clutch actuators generally incorporate a solenoid that is selectively actuated by connection to a power source to shift the release bearing.

Input shaft braking can improve transmission performance by increasing the speed of up shifting through available gear ratios. Input shaft braking is particularly important in lower gear ratios when operating a heavy vehicle on steep inclines at low speeds. Input shaft brakes have been developed that are shifted by a hydraulic or pneumatic control system to improve shift performance. One potential problem with fluid controlled input shaft brakes is that over time air leaks or oil leaks may develop. Generally, fluid controlled input shaft brakes do not lend themselves to operation with electric clutch actuators because they require extensive independent control systems that must be integrated with the electric clutch actuator system.

There is a need for an electric clutch actuator that can be integrally controlled and used to actuate an inertia brake. There is a particular need for such a system that can reduce the cost of an inertia brake system by utilizing electric clutch actuator components to operate the inertia brake.

These and other problems and needs are addressed by applicants' invention as summarized below.

### SUMMARY OF THE INVENTION

According to one aspect of the present invention, a transmission system is disclosed that includes a plurality of selectable gear sets that may be engaged to provide different gear ratios. The transmission system comprises an input shaft that supplies torque to the transmission system. A clutch selectively transfers torque to the input shaft. A release bearing is received on the input shaft and is axially moved relative to the input shaft to selectively release and engage the clutch. An electric actuator engages the release bearing to move the release bearing axially on the input shaft. An input shaft brake is disposed on the input shaft and has brake plates that selectively engage a rotor that rotates with the input shaft to apply a braking force to the input shaft. The release bearing is shifted by an electric clutch actuator in one axial direction to engage the clutch and in the opposite axial direction to both disengage the clutch and engage the input shaft brake after the clutch is disengaged to facilitate shifting between selectable gear sets.

According to another aspect of the present invention, a combination of a clutch and input shaft brake is provided for a multiple speed transmission system. The input shaft is intended to be selectively connected to a source of torque by a clutch. A release bearing is received by and axially moved on the input shaft to selectively release and engage the clutch. A clutch actuator engages the release bearing to move the release bearing axially on the input shaft. At least one reaction plate is provided that is non-rotatably mounted adjacent to a rotor that rotates with the input shaft to apply a braking force to the input shaft. The release bearing is shifted by the clutch actuator in one axial direction to engage the clutch and in the opposite axial direction to both disengage the clutch and engage the reaction plate.

According to other aspects of the invention, the clutch actuator may have a cross shaft that moves the actuator axially so that the cross shaft may operate both the clutch and the input shaft brake. The release bearing is coaxially received on the input shaft. The electric clutch actuator-is moved in a first direction to cause the release bearing to engage the clutch. The electric clutch actuator is moved in a second direction to disengage the clutch and engage the input shaft brake.

According to other aspects of the invention, The input shaft brake may comprise more than one reaction plate with each of the reaction plates being non-rotatably grounded to the clutch housing. Two reaction plates may be disposed on opposite sides of the rotor that are relatively axially movable to a limited extent. The release bearing applies an axial force to the first reaction plate that is driven into contact with the rotor. The rotor is axially shifted to engage the second reaction plate when the braking force is applied. A spring may operatively engage the first and second reaction plates to bias the reaction plates out of engagement with the rotor when the release bearing is not applying an axial force to the first reaction plate. The inertia brake may be a low capacity dry clutch type of inertia brake.

These and other aspects of the present invention will be better understood in view of the attached drawings and following detailed description of an illustrated embodiment of the invention.

### BRIEF DESCRIPTION OF THE DRAWINGS

FIG. 1 is a cross-sectional view of a clutch assembly having an electric clutch actuator and input shaft brake made in accordance with one embodiment of the present invention;

FIG. 2 is a diagrammatic half-section view of the clutch assembly showing the clutch engaged;

FIG. 3 is a diagrammatic half-section view of the clutch assembly at the release bearing touch point;

FIG. 4 is a diagrammatic half-section view of the clutch assembly at the clutch touch point;

FIG. 5 is a diagrammatic half-section view of the clutch assembly with the clutch fully open and the release bearing initially contacting the input shaft brake; and

FIG. 6 is a diagrammatic half-section view of the clutch assembly showing the clutch disengaged and the inertia brake fully engaged.

### DETAILED DESCRIPTION OF THE PREFERRED EMBODIMENT(S)

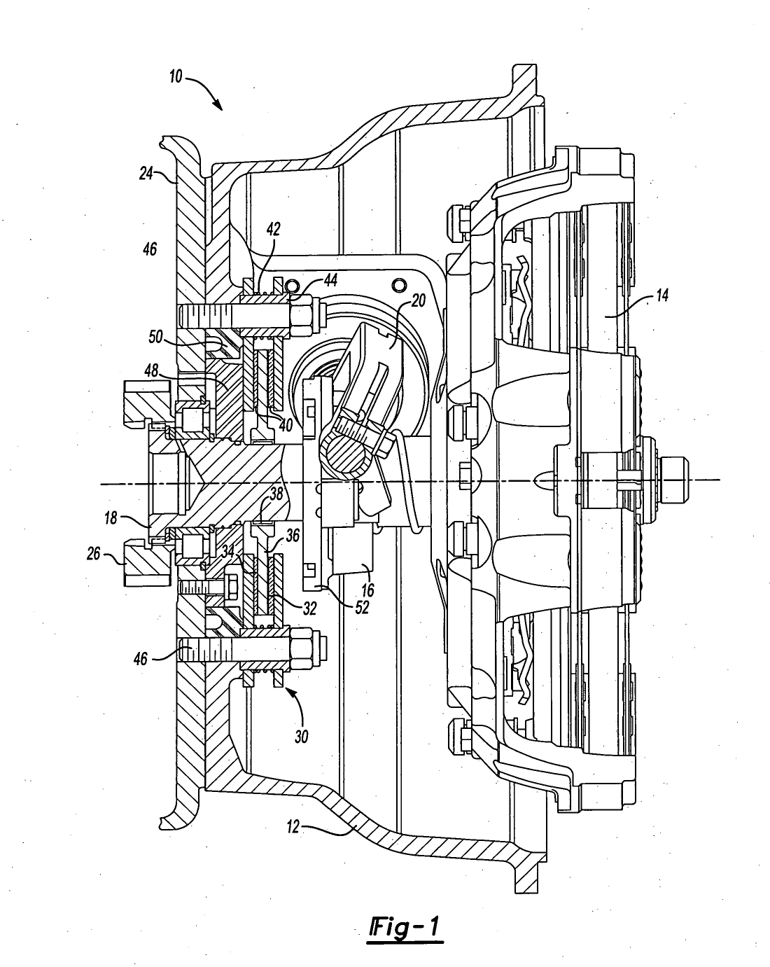

Referring to FIG. 1, a clutch is generally indicated by reference numeral 10. The clutch assembly 10 is at least partially enclosed within a clutch housing 12. A clutch 14 of conventional design is partially disposed within the clutch housing 12. A release bearing 16 have a sealed anti-friction bearing is provided on an input shaft 18. An electric clutch actuator 20 is coaxially received on the input shaft 18.

A transmission housing 24 is partially illustrated in FIG. 1 and the clutch assembly 10 is attached to the transmission housing 24. An input gear 26 is shown secured to the input shaft 18 within the transmission housing 24.

An input shaft inertia brake assembly is generally referred to by reference numeral 30. The input shaft inertia brake may be a low capacity dry clutch type of brake. Input shaft inertia brake assembly 30 includes a first reaction plate 32 and a second reaction plate 34. The reaction plates 32, 34 are non-rotatably assembled to the clutch housing 12. Alternatively, the second reaction plate could be formed as a portion of a release bearing cap. A rotor 36 is disposed between the first and second reaction plates 32 and 34. The rotor 36 is secured by splines 38 to the input shaft 18 to permit limited axial movement of the rotor 36. A layer of friction material 40 is provided on each of the reaction plates 32 and 34. The layer of friction material 40 could also be provided by permeating the reaction plates 32 and 34 with friction material as they are formed, for example, by means of a sintering process. The first and second reaction plates 32 and 34 are biased against engagement with the rotor 36 by a reaction spring 42. The reaction spring 42 is received on a reaction bushing 44 that is retained by bolts 46. Bolts 46 extend through the reaction bushing 44 and also may be used as shown to secure the clutch housing 12 to the transmission housing 24.

A bearing cap 48 is provided on the side of the clutch housing 12 that is secured to the transmission housing 24. The bearing cap 48 is provided with an annular seal member 50 that provides a seal around the periphery of the bearing cap 48.

The release bearing 16 includes an actuating plate 52 that is adapted to engage the first reaction plate 32 when the electric clutch actuator 20 is shifted to engage the input shaft inertia brake assembly 30.

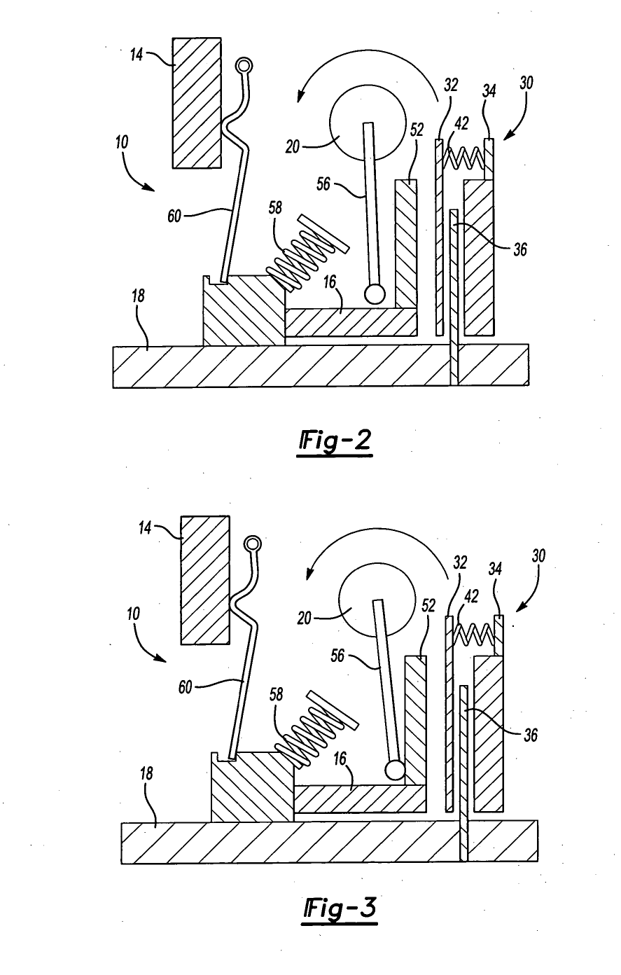

Operation of the electric clutch actuator and input shaft inertia brake assembly will be described below with reference to FIGS. 2-6.

Referring to FIG. 2, the clutch assembly 10 of the present invention is schematically represented. The clutch assembly 10 includes the clutch 14, release bearing 16, and input shaft inertia brake assembly 30. The release bearing 16 is coaxially received on the input shaft 18. It should be noted that only the upper half of the clutch assembly is shown. The electric clutch actuator 20 is provided with a cross shaft 56 that contacts the release bearing 16. The cross shaft 56 axially shifts the release bearing 16 relative to the input shaft 18. In FIG. 2, the release bearing is shown in the clutch engaged position in which the clutch springs 58 bias a plurality of levers 60 to engage the clutch 14. This is the position of the clutch when the transmission is engaged. The input shaft brake 30 is shown with the reaction spring 34 biasing the reaction plates 32 and 34 out of engagement with the rotor 36.

Referring to FIG. 3, the electric clutch actuator 20 is shown at the release bearing touch point (the electric clutch actuator 20 causes the cross shaft 56 to initially touch the release bearing 16 or actuating plate 52 that is connected to the release bearing 16). A solenoid (not shown) may be incorporated in the electric clutch actuator 20. At this point the clutch is still fully engaged and the input shaft inertia brake assembly 30 is not engaged.

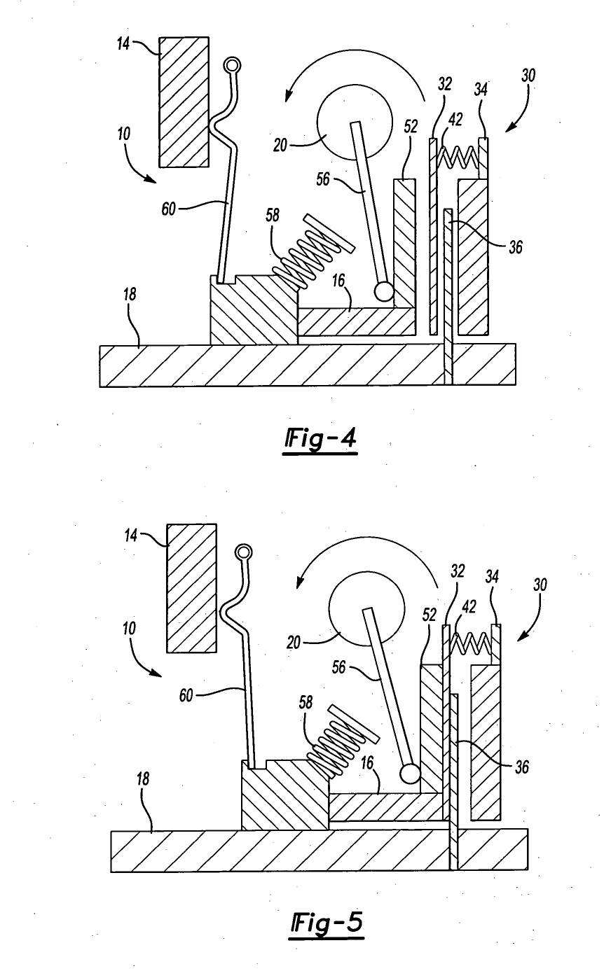

Referring to FIG. 4, the electric clutch actuator 20 is shown further rotated to cause the cross shaft 56 to shift the release bearing 16 toward input shaft brake assembly 30. Movement of the electric clutch actuator 20 also causes the levers 60 to move out of engagement with the clutch 14. The electric clutch actuator 20 is shown prior to engaging the first reaction plate 32.

Referring to FIG. 5, the clutch assembly 10 is shown with the electric clutch actuator 20 further rotated to fully release the clutch 14 and with the actuator 20 engaging the first reaction plate 32 of the input shaft inertia brake assembly 30. The first reaction plate 32 is shifted axially by the actuating plate 52 into engagement with the rotor 36.

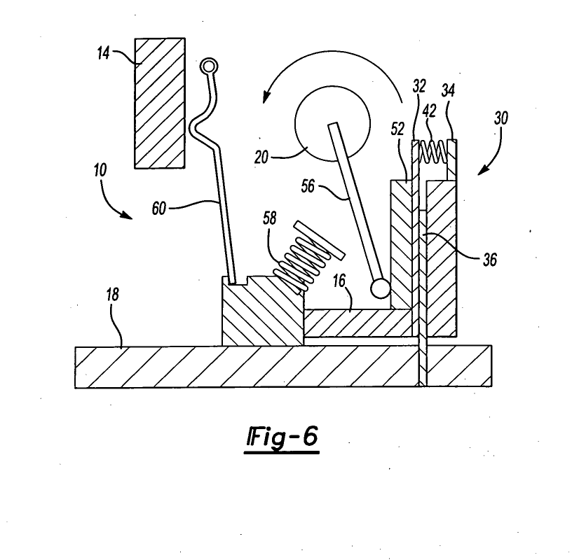

Referring to FIG. 6, the clutch assembly 10 is shown with the input shaft inertia brake assembly 30 fully engaged. The levers 60 in this position do not exert any substantial pressure on the clutch 14 and the release bearing 16 is shifted against the clutch springs 58. The release bearing 16 and actuating plate 52 shift the first reaction plate 32 and rotor 36 into engagement with the second reaction plate 34 against the biasing force of the reaction spring 42. The rotor 36 shifts axially on its splined connection to the input shaft 18. In this position, the input shaft inertia brake assembly 30 applies its full braking force to the input shaft 18. This slows the input shaft 18 and permits more rapid upshifting through available gear ratios.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A transmission system having a plurality of selectable gear sets that may be engaged to provide different gear ratios, comprising:
an input shaft that supplies torque to the transmission system;
a clutch that selectively transfers torque to the input shaft of the transmission system;
a release bearing that is received on the input shaft and is axially moved relative to the input shaft to selectively release and engage the clutch;
an electric clutch actuator operatively engaging the release bearing to move the release bearing axially on the input shaft;
an input shaft brake that is disposed on the input shaft, the input shaft brake having brake plates that selectively engage a rotor that rotates with the input shaft to apply a braking force to the input shaft; and
wherein the release bearing is shifted by the electric clutch actuator in one axial direction to engage the clutch and in the opposite axial direction to both disengage the clutch and engage the input shaft brake after the clutch is disengaged to facilitate shifting between selectable gear sets.

2. The transmission system of claim 1 wherein the electric clutch actuator has a cross shaft that moves the release bearing axially, wherein the electric clutch actuator operates both the clutch and the input shaft brake.

3. The transmission system of claim 1 wherein the inertia brake is a low capacity dry clutch type of inertia brake.

4. The transmission system of claim 1 wherein the electric clutch actuator in a first stroke in a first direction causes the release bearing to engage the clutch and in a second stroke in a second direction causes the release bearing to disengage the clutch and engage the input shaft brake.

5. The transmission system of claim 1 wherein the input shaft brake further comprises first and second reaction plates that are non-rotatably secured to the clutch housing, the reaction plates being disposed on opposite sides of the rotor and at least one reaction plate being axially moveable to a limited extent, an actuator plate of the release bearing applies an axial force to the first reaction plate that is driven into contact with the rotor, the rotor being axially shifted to engage the second reaction plate when the braking force is applied.

6. The transmission system of claim 5 wherein a reaction spring operatively engages the first and second reaction plates to bias the reaction plates out of engagement with the rotor when the release bearing is not applying an axial force to the first reaction plate.

7. The transmission system of claim 1 wherein the release bearing is coaxially received on the input shaft.

8. The transmission system of claim 7 wherein a cross shaft is provided that is axially moved by the electric clutch actuator and engages the release bearing to move the release bearing axially relative to the input shaft.

9. A clutch and input shaft brake, in combination, for a multiple gear set transmission system having a plurality of selectable gear sets that may be engaged to provide different gear ratios, comprising:
an input shaft that is adapted to be operatively connected to a source of torque;
a clutch that selectively connects the input shaft to the source of torque;
a release bearing received by and axially moved relative to the input shaft to selectively release and engage the clutch;
a clutch actuator engaging the release bearing to move the release bearing axially on the input shaft;
at least one reaction plate that is non-rotatably mounted adjacent to a rotor that rotates with the input shaft to apply a braking force to the rotor that is attached to the input shaft; and
wherein the release bearing is shifted by the clutch actuator in one axial direction to engage the clutch and in the opposite axial direction to disengage the clutch and engage the reaction plate.

10. The combination of claim 9 wherein the clutch actuator has a cross shaft that moves the release bearing axially to selectively engage the clutch and the reaction plate.

11. The combination of claim 9 wherein the inertia brake is a low capacity dry clutch inertia brake.

12. The combination of claim 9 wherein the clutch actuator in a first stroke in a first direction causes the release bearing to engage the clutch and in a second stroke in a second direction causes the release bearing to disengage the clutch and engage the reaction plate.

13. The combination of claim 9 wherein the input shaft brake further comprises first and second reaction plates that are non-rotatably secured to the clutch housing, the reaction plates being disposed on opposite sides of the rotor and being relatively axially moveable to a limited extent, the release bearing applying an axial force to the first reaction plate that is driven into contact with the rotor, the rotor being axially shifted on the input shaft to engage the second reaction plate when the braking force is applied.

14. The combination of claim 13 wherein a spring operatively engages the first and second reaction plates to bias the reaction plates out of engagement with the rotor when the release bearing is not applying an axial force to the first reaction plate.

15. The combination of claim 9 wherein the release bearing is coaxially received on the input shaft.

16. The combination of claim 15 wherein a cross shaft is provided that is axially moved by the clutch actuator and engages the release bearing to move the release bearing axially relative to the input shaft.
